(19) United States
(12) Patent Application Publication
(10) Pub. No.: US 2013/0186154 A1
(43) Pub. Date: Jul. 25, 2013

(54) KD

(71) Applicant: Alfred M. Haas, Oakhurst, NJ (US)

(72) Inventor: Alfred M. Haas, Oakhurst, NJ (US)

(21) Appl. No.: 13/684,232

(22) Filed: Nov. 22, 2012

Related U.S. Application Data
(60) Provisional application No. 61/563,031, filed on Nov. 22, 2011.

(51) Int. Cl. E05B 19/00

(52) U.S. Cl. CPC E05B 19/0088
USPC 70/336

(57) ABSTRACT

The invention disclosed herein relates to methods and means for opening, securing and/or operating vehicles, residences, locks, locked enclosures, and/or other machines and apparatuses, and for storing, processing, transmitting, receiving and displaying or otherwise outputting data or other information pertaining to vehicles, residences, locks, locked enclosures, and/or other machines and apparatuses, and/or pertaining to items, apparatuses, and/or entities which may be in such vehicles, residences, locked enclosures, and/or other machines and apparatuses. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/563,031 (“the '031 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '031 provisional and expressly incorporates by reference the disclosures contained therein in their entirety, including but not limited to all patents, patent applications, and publications which are incorporated by reference in the '031 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc. . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc. . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: thermostats, e-readers (e.g. Kindle™ and Nook™), hearing aids, laptop and desktop computers, alarms, smart phones, PDAs, other commercially available electronic devices such as tablet PCs, netbooks, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc. . . .

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of embodiments of the disclosed invention—including, but not limited to, software and hardware such as sensors and transducers, circuits, transmitters, receivers, housings, wearable and other mobile devices, optics, programmable logic elements and chips, custom ASICs, electrical and mechanical switches, electrical and mechanical regulators, etc.: Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The invention disclosed herein relates to methods and means for opening, securing and/or operating vehicles, residences, locks, locked enclosures, and/or other machines and apparatuses, and for storing, processing, transmitting, receiving and displaying or otherwise outputting data or other information pertaining to vehicles, residences, locks, locked enclosures, and/or other machines and apparatuses, and/or pertaining to items, apparatuses, and/or entities which may be in such vehicles, residences, locked enclosures, and/or other machines and apparatuses.

### BRIEF DESCRIPTION OF THE SEVERAL VIEWS OF THE DRAWING

FIG. 1 shows a side view of one specific example of an embodiment of a key according to the instant invention.

FIG. 2 shows a top-down view of one specific example of an embodiment of a key according to the instant invention.

FIG. 3 shows a side view of another specific example of an embodiment of a key according to the instant invention.

FIG. 4 shows a side view of a specific example of an embodiment of a key according to the instant invention.

FIG. 5 shows a top-down view of a specific example of an embodiment of a key according to the instant invention.

### DETAILED DESCRIPTION OF THE INVENTION

The invention disclosed herein relates to methods and means for opening, securing and/or operating vehicles, residences, locks, locked enclosures, and/or other machines and apparatuses, and for storing, processing, transmitting, receiving and displaying or otherwise outputting data or other information pertaining to vehicles, residences, locks, locked enclosures, and/or other machines and apparatuses, and/or pertaining to items, apparatuses, and/or entities which may be in such vehicles, residences, locked enclosures, and/or other machines and apparatuses.

Although it is not believed that drawings are necessary for the understanding of the subject matter sought to be patented, for illustrative purposes we have included several figures related to specific examples of embodiments of the disclosed invention.

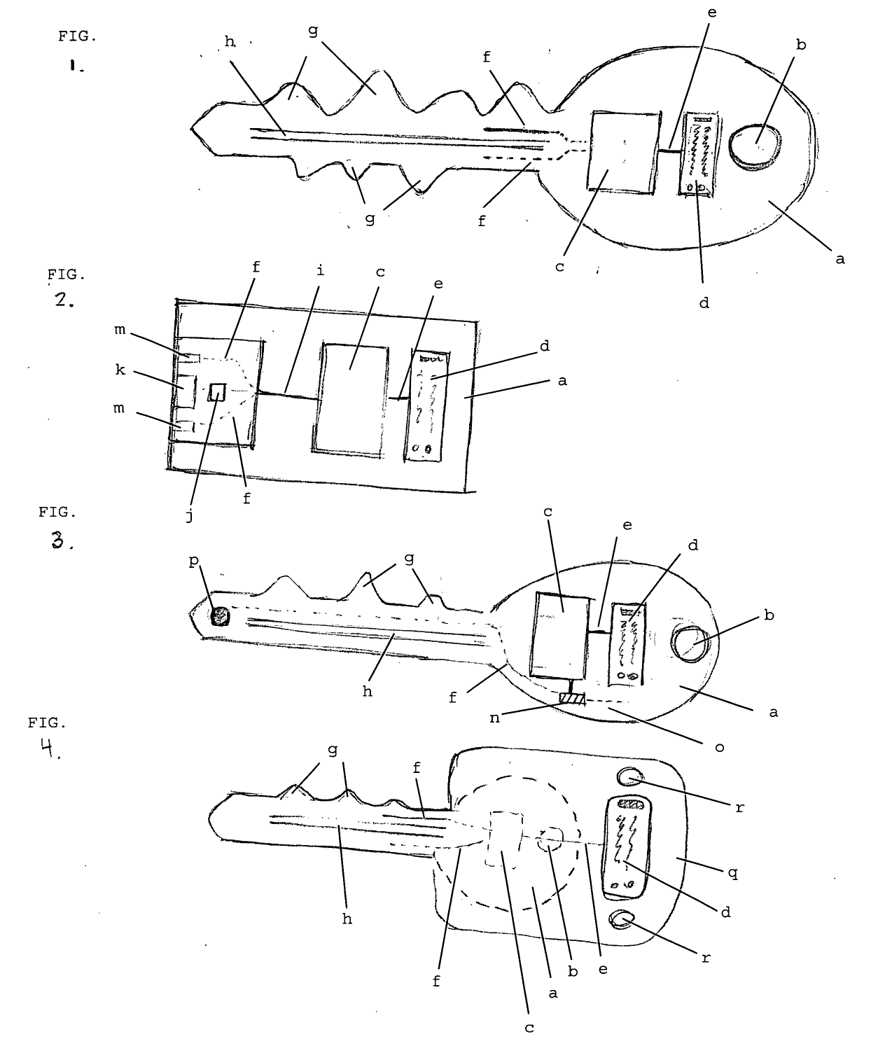

FIG. 1 shows a side view of one specific example of an embodiment of a key according to the invention, comprising: (a) a key body; (b) a hole through the key body; (c) hardware; (d) a display; (e) a bus; (f) electrical connections; (g) teeth; and (h) a groove In this specific example, the key body, (a), comprises a handle and a blade, wherein the blade comprises a portion of the key body having teeth, (g), and the handle comprises a portion of the key body having hardware, (c), display, (d), and hole, (b). In this specific example, hardware comprises circuits for of storing, processing, transmitting, receiving and driving display and speakers. More specifically, the hardware schematically represented by (c) comprises a processing unit, a communications module—in this specific example, comprising a transceiver with antenna—for communicating with other circuits, components, devices, systems, networks and individuals, a display driver, speaker drivers and input channels, power conditioning circuits, memory, and a power supply. Illustrative examples of a power supply include, but are not limited to, a battery and battery holder, solar cells and associated charging circuitry, a plug for receiving wall power with or without associated circuitry (such as electrical transformers, rectifiers, voltage regulators, capacitors, etc.), an inductive power receiver element (such as a coil and circuitry to receive inductively coupled power), an electromechanical generator (think self-winding watch), a thermal generator (think MEMS/NEMS generators), and any other suitable source of power.

FIG. 2 illustrates a top-down view of another specific example of an embodiment of the invention, comprising: (a) a key body; (c) hardware; (d) a display; (e), (i) buses; (f) electrical connections; (j) an encoder/decoder; (k) a programmable magnetic surface; and (m) electrodes. In this specific example, the key body, (a), comprises an electrical insulator card with embedded hardware, (c), display, (d), programmable electromagnetic surface, (k), and means for programming and interfacing with that surface, (j).

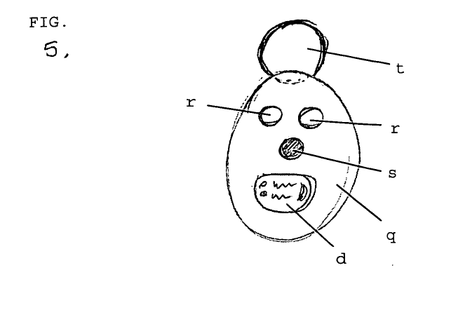

FIG. 3 shows a side view of one specific example of an embodiment of the invention, comprising: (a) a key body; (b) a hole through the key body; (c) hardware; (d) a display; (e) a bus; (f) electrical connections; (g) teeth; (h) a groove; (n) a separate transceiver; (o) an antenna; and (p) a coil. In this specific example, the key body, (a), comprises a handle and a blade, wherein the blade comprises a portion of the key body having teeth, (g), and a groove, (h), and the handle comprises a portion of the key body having hardware, (c), bus, (e), display (d), and hole (b). The antenna may receive electromagnetic (“EM”) signals and the hardware and/or separate transceiver may use the antenna to transmit EM signals. Similarly, the coil may be used to transmit and/or receive EM signals, whose captured energy may be used to recharge the power supply.

FIG. 4 shows a side view of yet another specific example of an embodiment of the invention, comprising: (a) a key body; (b) a hole through the key body; (c) hardware; (d) a display; (e) a bus; (f) electrical connections; (g) teeth; (h) a groove; (r) buttons; and (q) a housing. In this specific example, the key body, (a), comprises a handle and a blade, wherein the blade comprises a portion of the key body having teeth, (g), and a groove, (h), and the handle comprises a portion of the key body having hardware, (c), bus, (e), display (d), and hole (b). The housing, (q), encloses the handle of the key body, (a), and further comprises a transparent window through which a visible portion of the display, (d), may be viewed. A speaker is not shown, but also embedded in the housing of this specific embodiment.

FIG. 5 shows a top-down view of another specific example of an embodiment of a key according to the instant invention comprising: (d) a display; (q) a housing; (r) buttons; (s) a speaker; and (t) a key ring. FIG. 5 is meant to illustrate that an enhanced key according to the instant invention need not comprise a conventional key body, but instead may comprise a housing and electronic hardware. In this specific embodiment, hardware enclosed in the housing comprises a processor, a separate transceiver, and antenna, and a battery. The embodiment disclosed in FIG. 5 does not comprise a conventional mechanical key, but instead an electronic key using EM transmissions and communication to open, secure and/or operate one or more of a vehicle, a residence, and/or a lock.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A means comprising hardware for opening, securing and operating vehicles, residences, locks, locked enclosures, and/or other machines and apparatuses, and for storing, processing, transmitting, receiving and displaying or otherwise outputting data or other information pertaining to vehicles, residences, locks, locked enclosures, and/or other machines and apparatuses, and/or pertaining to items, apparatuses, and/or entities which may be in such vehicles, residences, locked enclosures, and/or other machines and apparatuses.

2. The means of claim 1 wherein the hardware comprises one or more of a cell phone, a tablet computer, a worn device comprising a microprocessor, and a personal digital assistant.

3. A method for opening, securing and operating vehicles, residences, locks, locked enclosures, and/or other machines and apparatuses, and for storing, processing, transmitting, receiving and displaying or otherwise outputting data or other information pertaining to vehicles, residences, locks, locked enclosures, and/or other machines and apparatuses, and/or pertaining to items, apparatuses, and/or entities which may be in such vehicles, residences, locked enclosures, and/or other machines and apparatuses.

4. The method of claim 3 wherein one or more steps of the method involves the use of hardware comprising one or more of a cell phone, a tablet computer, a worn device comprising a microprocessor, and a personal digital assistant.
